(19) United States
(12) Patent Application Publication
(10) Pub. No.: US 2025/0081114 A1
(43) Pub. Date: Mar. 6, 2025

(54) RANGE EXTENSION OF AMBIENT INTERNET OF THINGS DEVICES

(71) Applicant: Nokia Technologies Oy, Espoo (FI)

(72) Inventor: Muhammad Majid BUTT, Naperville, IL (US)

(73) Assignee: Nokia Technologies Oy, Espoo (FI)

(21) Appl. No.: 18/816,227

(22) Filed: Aug. 27, 2024

(30) Foreign Application Priority Data
Sep. 1, 2023 (FI) 20235978

(51) Int. Cl. H04W 52/02; H02J 50/00; H02J 50/20

(52) U.S. Cl. CPC H04W 52/0261; H02J 50/001; H02J 50/20

(57) ABSTRACT

Method, apparatus, and device for communicating with an extended range. The apparatus is a network apparatus communicating with an ambient internet of things device having an energy storage and capability to transmitting data by backscattering a radio transmission. The apparatus detects that the device has failed to transfer data by backscattering and responsively sends to the device a first radio transmission having instructions to decrease a radio reflection coefficient to increase wireless energy harvesting. The device decreases the radio reflection coefficient accordingly. The device detects sufficient wireless charging of its energy storage with the decreased radio reflection coefficient and increases the radio reflection coefficient accordingly.

### TECHNICAL FIELD

Various example embodiments relate to range extension of ambient internet of things devices.

### BACKGROUND

This section illustrates useful background information without admission of any technique described herein representative of the state of the art.

Ambient Internet of Things (AIoT) devices come in a variety of different types including those that use backscattering to reflect an energising radio signal to an AIoT access point and comprise a chargeable energy storage such as a battery or capacitor. The energy storage may enable communication with a greater range in case that the AIoT device can use the stored energy for operating its processing equipment (and may include minimum energy to activate backscattering transmission) and reflect as much radio energy as possible to the access point, also called reader. However, in such a case, the energy storage needs to be charged in advance. Since the AIoT devices might not be conveniently chargeable by anyone and charging connectors incur expense and some structural requirements, separate charging is not always possible. On the other hand, without an energy storage, the AIoT device must continuously receive at least as much energy as needed to run its processing equipment and reflect enough radio energy to the access point. Hence, effective range of a battery-less AIoT device may significantly suffer. Moreover, the radio conditions are also prone to fluctuate through a number of reasons. Even if the AIoT could sufficiently operate at a given range for a portion of required time, loss of connectivity and perhaps entire operating power of processing equipment of the AIoT may prevent desired operation of the AIoT device.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first example aspect, there is provided a device as defined by appended claim 1.

According to a second example aspect, there is provided an apparatus as defined by appended claim 4.

According to a third example aspect, there is provided a method as defined by appended claim 10.

According to a fourth example aspect, there is provided a method as defined by appended claim 12.

According to a fifth example aspect, there is provided a computer program comprising computer executable program instructions configured to cause performing the method of the third or fourth example aspect.

The computer program may be stored in a computer readable memory medium. The memory medium may comprise a digital data storage such as a data disc or diskette, optical storage, magnetic storage, holographic storage, opto-magnetic storage, phase-change memory, resistive random-access memory, magnetic random-access memory, solid-electrolyte memory, ferroelectric random-access memory, organic memory, or polymer memory. The memory medium may be formed into a device without other substantial functions than storing memory or it may be formed as part of a device with other functions, including but not limited to a memory of a computer, a chip set, and a sub assembly of an electronic device.

According to a sixth example aspect, there is provided an apparatus comprising at least one processor and at least one memory storing instructions that, when executed by the processor, cause the apparatus to perform the method of the third or fourth example aspect.

According to a seventh example aspect, there is provided an apparatus comprising means for performing the method of the third example aspect.

According to an eighth example aspect, there is provided a device comprising means for performing the method of the fourth example aspect.

According to a ninth example aspect, there is provided an apparatus comprising
a first circuitry configured to cause communicating with a device, wherein the device is an ambient internet of things device with an energy storage and wherein the device is capable of transmitting data by backscattering a radio transmission;
a second circuitry configured to cause detecting that the device has failed to transfer data by backscattering;
a third circuitry configured to cause, based on the detecting, sending to the device a first radio transmission comprising instructions to decrease a radio reflection coefficient to increase wireless energy harvesting;
a fourth circuitry configured to cause monitoring for backscattered information from the device.

According to a tenth example aspect, there is provided a device comprising
a fifth circuitry configured to perform receiving a first radio transmission comprising instructions to decrease a radio reflection coefficient to increase wireless energy harvesting to an energy storage;
a sixth circuitry configured to perform decreasing the radio reflection coefficient according to the received instructions to increase wireless energy harvesting to the energy storage;
a seventh circuitry configured to perform detecting that the energy storage is sufficiently charged with the wireless energy harvesting; and
an eighth circuitry configured to perform increasing the radio reflection coefficient to backscatter outgoing data based on the detecting that the energy storage is sufficiently charged with the wireless energy harvesting.

Different non-binding example aspects and embodiments have been illustrated in the foregoing. The embodiments in the foregoing are used merely to explain selected aspects or steps that may be utilized in implementations. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments, reference is now made to the following descriptions taken in connection with the accompanying drawings in which:

FIG. 1 shows an architectural drawing of a system of an example embodiment;

FIG. 2 shows a simplified backscattering circuitry of an example embodiment;

FIG. 3 shows a block diagram of an apparatus of an example embodiment;

FIG. 4 shows a block diagram of a device of an example embodiment.

FIG. 5 shows a simplified signalling chart of a process of an example embodiment;

FIG. 6 shows a simplified flow chart of a process of an example embodiment;

FIG. 7 shows a simplified flow chart illustrating various features of different example embodiments; and

FIG. 8 shows a simplified flow chart illustrating various features of different further example embodiments.

### DETAILED DESCRIPTION

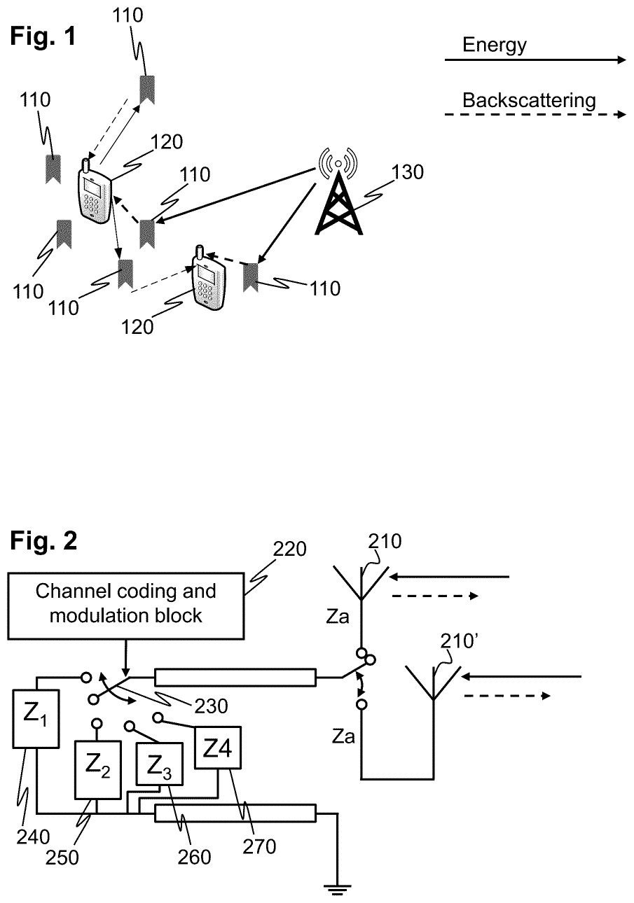

An example embodiment and its potential advantages are understood by referring to FIGS. 1 through 8 of the drawings. In this document, like reference signs denote like parts or steps.

FIG. 1 shows an architectural drawing of a system. In FIG. 1, a number of ambient internet of things devices 110, or devices in short, reside in some environment. These devices may be standalone parts or fixed or embedded to various goods or items, such as parcels, vehicles, household appliances, mobile phones, generally anything. In comparison to simple radio frequency identifier (RFID) or near field communication (NFC) devices, the ambient IoT, AIoT, devices may be capable of co-operating with modern 3GPP cellular networks and covered by specifications of new 3GPP standards. For example, the AIoT device may be referred to as a tag.

FIG. 1 further shows a number of compatible network apparatuses including monostatic or bistatic access points 120, and an illuminator 130 configured to illuminate devices with an energising radio transmission without necessarily reading any radio signals communicated by the devices. The illuminator may be, for example, a network node, such as a gNB. The access points may include, for example, user equipment, UE. In some embodiments, the access point may also act as an illuminator. Thus, UE may act as the illuminator as well. An access point may be configured with monostatic configuration, wherein the same access point is configured to illuminate the AIoT device and read signals backscattered by the AIoT devices. Access points may be configured with bistatic configuration, wherein a first access point or an illuminator is configured to perform the illumination and a second access point configured to read the backscattering signals. FIG. 1 shows an example of an access point configured to operate as a monostatic access point for given devices. In an example embodiment, at least some of the access points 120 are capable of simultaneously operating in the monostatic configuration for a first set of AIoT devices 110 and in the bistatic configuration for a second set of AIoT devices 110 as a reader or as an illuminator. FIG. 1 also shows an example of an access point configured to operate as a bistatic element for other devices.

FIG. 2 shows a simplified backscattering circuitry comprised in an AIoT device of an example embodiment. An antenna 210 is provided for receiving a radio transmission and backscattering outgoing data. A channel coding and modulation block 220 controls forming of the backscattering by controlling a switch 230 that is here drawn as being controllable to connect the antenna with one of a plurality of impedances. The plurality of impedances may comprise, for example, a first impedance Z1 240, a second impedance Z2 250, a third impedance Z3 260, and a fourth impedance Z4 270, and possibly further impedances. In at least some embodiments, the backscattering circuitry has exactly three impedances, e.g., Z1 and Z2 and Z3, and the switch 230 is configured to connect the antenna with one of the three impedances. In an example embodiment, the backscattering has exactly two impedances Z1 and Z2. In an example embodiment, the backscattering circuitry is adaptable to operate with two or more different radio reflection coefficients, RC, by selectively connecting to one of a plurality of different antennas. FIG. 2 shows for illustration purpose another antenna 210′. The antennas 210, 210′ may differ by their gain in a frequency band used for the backscattering.

In an example embodiment, any of the devices 110, access points 120, and illuminators may be compatible with a 3GPP technical recommendation TR 22.840: Study of Ambient IoT. That recommendation particularly lists following types of Ambient AIoT devices:
Device A: No energy storage, no independent signal generation or amplification, i.e., backscattering transmission.
Device B: Energy storage, no independent signal generation or amplification, i.e., backscattering transmission. Use of stored energy can include amplification for reflected signals.
Device C: Energy storage, independent signal generation, i.e., active RF components for transmission.

Type A and Type B both are passive energy harvesting IoT devices without and with an energy storage, respectively. In a type B device, the energy storage can be used to amplify the signal and extend transmission range. This can be used either by using an amplifier at the device or just dynamically adjusting the reflection coefficient. However, it is observed that adding an amplifier to an AIoT device increases cost and size of the AIoT device.

As mentioned in the foregoing, for a backscattering AIoT device, an illumination signal is used to power the AIoT device as well as to enable backscattering information. The backscattering modulates the radio transmission incident on the AIoT device by reflection with a level of antenna mismatch that is adjusted to alter an RC circuit as illustrated in FIG. 2. Further, such passively communicating devices may perform energy harvesting (EH) from the ambient RF signals for supporting its circuit operation.

Let us consider that how the backscattering circuitry of the AIoT device operates with two impedances, or two different states, for channel coding and modulation with backscattering. In this case, the AIoT device is switched between absorbing and reflecting states by switching between two separate loads such that the absorbing state indicates bit ‘0’ transmission and the reflecting state indicates the bit ‘1’. A radio reflection coefficient 0 means all energy is absorbed/harvested by the AIoT device while 1 means that energy is reflected by a radio reflection coefficient 0<α<1. The AIoT device requires (1−α) fraction of the illumination signal power P to power its circuit.

In an example embodiment, the AIoT device is configured to have more than two different states that are needed for channel coding and modulation with backscattering. For example, there may be provided an increased radio reflection coefficient that is closer to one than in normal backscattering. In an example embodiment, the AIoT device is configurable to at least an energy harvesting state in which the radio reflection coefficient is as close to zero as possible; a normal operation state in which the radio reflection coefficient higher but clearly below one to allow sufficient energy harvesting for various circuitries, such as processing and volatile memory circuitries; and a range extending state in which the radio reflection coefficient is as close to zero as possible so as to reach maximum range for outgoing data that is backscattered.

In an example embodiment, the radio reflection coefficient is defined by an equation:

αᵢ=(Zᵢ−Zₐ*)/(Zᵢ+Zₐ), where Zₐ is antenna impedance, * is a complex-conjugate operator, and i=1, 2, . . . represents switch state. For example, switch state 1 corresponds to a situation that the switch is connected to Z1 and switch state 2 corresponds to a situation that the switch is connected to Z2.

In sake of clarity, it is explicitly noted that the term backscattering refers herein to varying reflection of the radio transmission regardless of that whether the receiver (reader) of backscattered signals is the same apparatus (illuminator) that emitted the radio transmission (monostatic case) or a different apparatus (bistatic case).

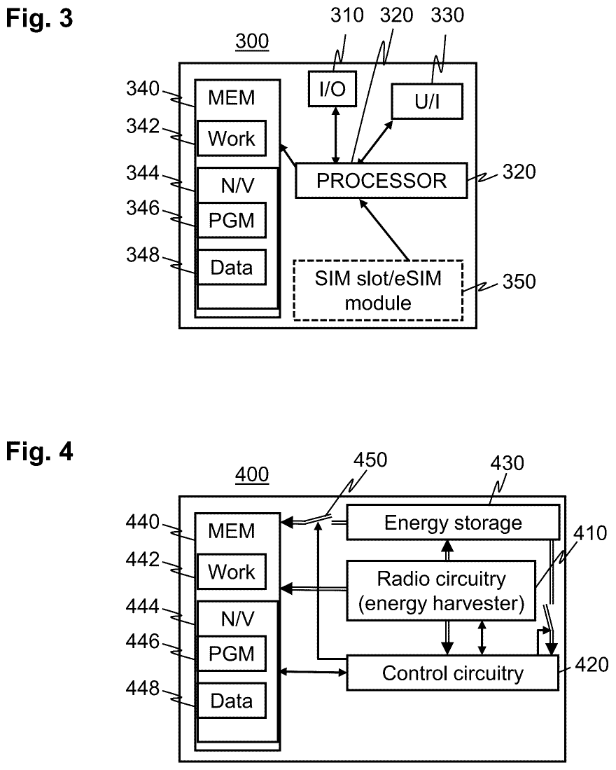

FIG. 3 shows a block diagram of an apparatus 300 according to an embodiment of the invention. The apparatus 300 of FIG. 3 may be usable as the access point 120 that can communicate with ambient internet of things devices 110.

The apparatus 300 comprises a memory 340 including a work memory 342 and a non-volatile memory 344 that contains computer program code 346 and data, such as pre-configured rules or configuration information. The apparatus 300 further comprises a processor 320 for controlling the operation of the apparatus 300 using the computer program code 346, a communication unit 310, such as a new radio capable of 5G cellular communications, for communicating with user equipment and cellular network. The communication unit 310 comprises, for example, a local area network (LAN) port; a wireless local area network (WLAN) unit; Bluetooth unit; cellular data communication unit; or satellite data communication unit. The communication unit 310 further comprises a proximity communication circuitry that is capable of communicating with ambient internet of things devices. In an example embodiment, the communication unit 310 further comprises a radio energiser for wirelessly energising devices capable of wirelessly harvesting energy from the radio transmission.

The processor 320 comprises, for example, any one or more of: a master control unit (MCU); a microprocessor; a digital signal processor (DSP); an application specific integrated circuit (ASIC); a field programmable gate array; and a microcontroller. The processor may function as a controller of the apparatus. The apparatus 300 further comprises a user interface 330, comprising, e.g., any one or more of a display, touch screen, button, microphone, speaker, fingerprint reader. In an example embodiment, the apparatus 300 further comprises a programmable subscriber identity module or a slot for receiving a subscriber identity module, 350.

FIG. 4 shows a simplified block diagram of a device 400 that may be capable of operating as an ambient internet of thigs device of an example embodiment. The device 400 may be a type B AIoT device, which comprises an energy storage and which relies on backscattering transmission. For example, the device 400 does not have independent transmission signal generation.

The device 400 comprises a memory 440 including a work memory 442 and a non-volatile memory 444 that contains computer program code 446 and data, such as pre-configured rules or configuration information. The device 400 further comprises a control circuitry 420 for controlling the operation of the device 400 using the computer program code 446. The device further comprises a radio circuitry 410, that is capable of communicating with backscattering based on incoming radio transmissions, and to harvest energy from radio signals to energise the device 400.

The processing circuitry 420 comprises, for example, any one or more of: a master control unit (MCU); a microprocessor; a digital signal processor (DSP); an application specific integrated circuit (ASIC); a field programmable gate array; and a microcontroller. The device 400 further comprises an energy storage 430. In an example embodiment, the energy storage 430 comprises a rechargeable battery. In an example embodiment, the energy storage 430 comprises a capacitor.

In an example embodiment, at least part of harvested energy is stored into the energy storage 430.

When operating, the device 400 may use the harvested energy for backscattering while storing energy to the storage 430, or while not storing energy to the energy storage 430. As drawn in FIG. 4, the device 400 may comprise a controllable switch 450 that is controllable by the control circuitry to either connect or disconnect the memory 440 from the energy storage. In FIG. 4, potential power transfer connections are drawn by a double line. Notably, power may be transferred from the radio circuitry 410 to the memory whenever the radio circuitry 410 is capable of wirelessly harvesting energy with a sufficient voltage.

As mentioned, the AIoT device, such as a tag may radiate around some energy of the radio transmission in the backscattering. Moreover, the AIoT device may additionally or alternatively harvest some energy with the radio circuitry 410 from the radio transmission. Some of the harvested energy may be used simultaneously by various circuitries of the AIoT device while a remaining portion may be stored into the energy storage 430. In an example embodiment, the entire harvested energy is stored into the energy storage 430 before using. In an example embodiment, a two-stage range extension is provided for an AIoT device type B. A first stage provides for attempting to fully absorb/harvest energy by setting a small radio reflection coefficient α (close to zero) and storing harvested energy in the energy storage 430. This stored energy can later be used to power and operate a circuitry or circuitries of the AIoT device in a second stage, where backscattering is provided by setting a larger radio reflection coefficient α>>0 or α≈1 and minimum energy to energise transmission can be used from the storage. This increased a will help increasing reflected power and range extension for type B backscattering devices.

In an example embodiment, a very small energy storage is required for the device of type B. This energy storage should be able to hold enough energy to operate the circuitry or circuitries of the AIoT device for a short period of time, such that backscattering can be performed by using relatively large radio reflection coefficient α. It is understood that any excess stored energy may not be needed for the AIoT device as the AIoT device cannot use it to boost its transmission power anyway in absence of active transmission capability, such as amplification of radio signals.

In an example embodiment, the access point attempts to communicate with the AIoT device without any knowledge of a) an amount of energy stored in the energy storage of the AIoT device, b) a rate with which energy can be stored in the energy storage in the AIoT device, and c) an amount of remaining capacity of the energy storage. If the AIoT device is not successful to transfer information by backscattering such that the access point would detect the transfer of the information, the access point attempts to cause the AIoT device to initiate an enhanced backscattering process. In an example embodiment, the AIoT device begins to wirelessly harvest a larger amount of energy to its energy storage with a reduced radio reflection coefficient, until the AIoT device detects having stored sufficiently energy to its energy storage. Then, the AIoT device begins to energise at least some of its circuitries by the energy stored in the energy storage and to communicate using backscattering with an increased radio reflection coefficient, as absorption of energy can be avoided or at least reduced. With the increased radio reflection coefficient, information transmitted by the AIoT device can be transferred more reliably to a receiver, such as the access point or a reader that is controlled by the access point.

In an example embodiment, the access point is any device connected to the network, e.g., a 3GPP device, including a gNB, a smartphone, etc. A monostatic configuration or a bistatic configuration may be used.

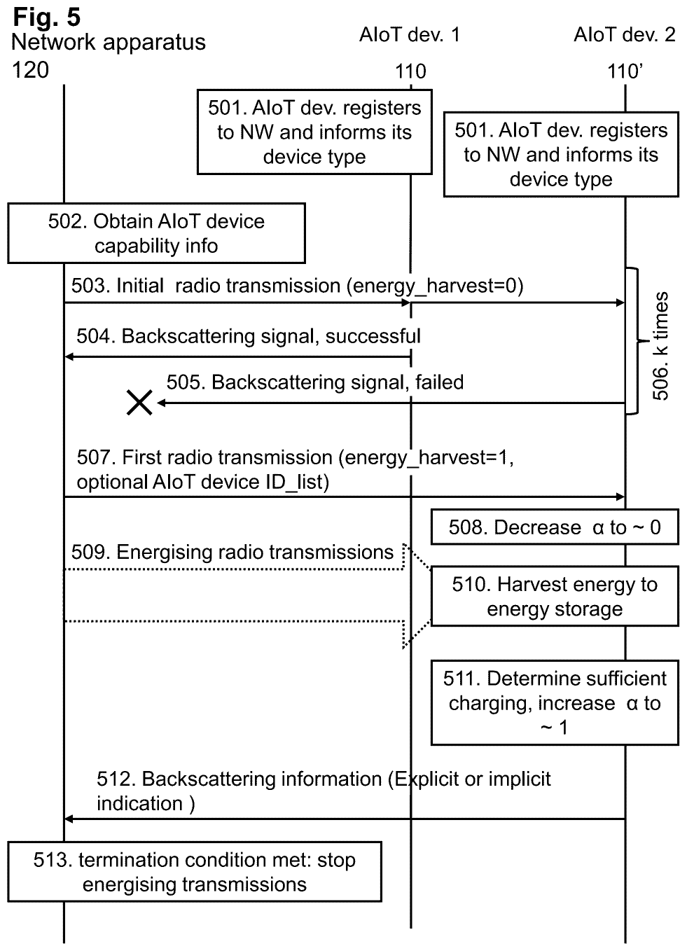

FIG. 5 shows a simplified signalling chart of an example embodiment to help explaining some example embodiments. In an example embodiment, the network apparatus is the illuminator, which is, for example, a 5G node B, gNB or UE. Two AIoT device type B devices 110, 110′ are shown in FIG. 5, as a first AIoT device 110 and a second AIoT device 110′. A procedure is mainly explained between the access point 120 and the second AIoT device 110′. It should be understood that the second AIoT device as well as any further AIoT devices may receive illumination signals and use those for absorbing and storing energy.

FIG. 5 shows step 501, registering the AIoT devices with the network. The AIoT devices inform the network of their device type (e.g., type B in this case). In this way, the network gains knowledge about availability of an energy storage at the AIoT devices the operation with which is next described for some example embodiments. Notably, the network may in parallel co-operate with devices of other types. Here, the network includes any devices that operate with 3GPP, e.g., the gNB or the UE. Naturally, the registration information may be stored in a register, but capability information of the AIoT devices is available in the network.

In step 502, the access point obtains capability information of the AIoT devices. In case that the registration was performed through the access point, the access point may simply obtain and maintain this knowledge. In an example embodiment, the access point is informed by the network of identifiers of the AIoT devices, and the access point obtains the capability information of the AIoT devices from a register. The access point may obtain the capability information by pulling or be provisioned with the capability information by the network.

In step 503, on intending to enhance wireless charging of an AIoT device (or a set of AIoT devices), the access point sends an initial radio transmission, such as energy_harvest=0 to command the AIoT device(s) to attempt a normal backscattering mode. The normal backscattering mode means backscattering without a range extension process. Notice: if the illuminator is not co-hosted with the access point, the then access point may control the illuminator with commands or requests sent to the illuminator. In sake of simplicity, it is here assumed that the access point and the illuminator are co-hosted, or the access point can control the illuminator. In FIG. 5, both the first AIoT device 110 and a second AIoT devices 110′ receive the radio transmission. Especially if the illuminator is not co-located with the access point, both the first AIoT device 110 and the second AIoT device 110′ may even receive the radio transmission with same power level. However, they may and typically do reside at different distance or at least with a different radio signal attenuation because of different intermediate absorbing or reflecting objects so that their radio output is received differently by the access point, as is the case in this drawing.

In step 504, the first AIoT device 110 normally backscatters information on receiving the initial radio transmission. This information is successfully communicated readable to the access point 120.

In step 505, the second AIoT device 110′ also normally backscatters information on receiving the initial radio transmission but due to poor wireless link that the access point 120 does not receive the backscattered information. Hence, the access point 120 knows that the range of the second AIoT device 110′ may not suffice. Notably, some AIoT devices may fail to receive the initial radio transmission sufficiently to even attempt backscattering information, in which case they would simply not backscatter anything. The access point 120 may detect that it has not received backscattering signal for a predetermined time period. Based on that, the access point 120 may determine that backscattering by the second AIoT device 110′ has failed, or that the device has performed the backscattering, but the range is not long enough. Alternatively, if another access point is communicating with the device, an indication may be received from that another access point that no backscattering has been received from the device 110′.

In step 506, the transmission of the initial radio transmission and attempting to read responsive backscattering signals is performed k times, wherein k is a finite integer, such as 1, 2, 3, 4, 5, 6, 7, 8, 9, or 10. The value of k may be greater than 1, or greater than 5, for example. With k greater than 1, temporary radio path problems may be overcome.

In step 507, in beginning of a charging phase, the access point 120 sends a first radio transmission to the AIoT devices or particularly to the second AIoT device 110′. The first radio transmission comprises instructions, such as a signal energy_harvest=1, to the AIoT devices concerned not to backscatter but rather to absorb more energy from the energising radio transmission and store the absorbed energy for later use. In an example embodiment, the access point sends an indication of intended AIoT device(s) target for these instructions, such as an ID_list to let a group of AIoT devices know that the radio transmission is available for harvesting energy to the energy storage. Note that the intended AIoT device (as well as possible other AIoT devices not intended to participate in this incremental energy boost) does not perform any backscattering in this step so there is no transmission by backscattering by the AIoT device in question.

In step 508, the second AIoT device 110′ reduces its radio reflection coefficient to zero or close to zero so as to harvest energy to its energy storage for operation of circuits of the AIoT device later without need or with reduced need to consume power of the radio transmission when the AIoT device is expected to backscatter information to the network.

In step 509, the first AIoT device 110 is energised or illuminated by a radio transmission or radio transmissions by the access point or network apparatus 120, or by another network device. These radio transmissions may be referred to as energising radio transmissions. The energising radio transmissions are provided to enable the AIoT device to wirelessly harvest energy to its energy storage. As the energising radio transmission or transmissions continue for the duration of energy harvesting, a wide arrow is drawn.

In step 510, the second AIoT device 110′ harvests energy to its energy storage from the energising radio transmission or radio transmissions. In an example embodiment, the second AIoT device 110′ continues to absorb/harvest energy until a storage threshold is reached. This storage threshold may reflect an amount of energy that the second AIoT device 110′ needs for operating its circuitry or circuitries while backscattering with an increased radio reflection coefficient. Storing energy beyond this threshold may not be helpful for range extension in the absence of a power-consuming active transmission circuitry, so the energy storage may not be charged even to its full capacity. Hence, the degradation of the energy storage by aging may not immediately impair operation of the second AIoT device 110′.

In step 511, the second AIoT device 110′ determines that there is sufficiently energy in the energy storage and sets the radio reflection coefficient α as close to 1 as possible for increased backscattering.

In step 512, the second AIoT device 110′ backscatters information to the access point. In an example embodiment, this information comprises explicit indication that the second AIoT device 110′ is ready to backscatter information. In an example embodiment, this information comprises an implicit indication that the second AIoT device 110′ is ready to backscatter information.

In an example embodiment, the explicit indication is provided such that the second AIoT device 110′ sends a short message by backscattering, e.g., Tx_request, to let access point know that the second AIoT device 110′ is now ready to backscatter with an increased radio power, as a result from using the increased radio reflection coefficient α. The explicit indication is modulated on the radio transmission received from the access point. On receiving this explicit indication, the access point may stop the radio transmissions, at least if solely transmitted for energising the second AIoT device 110′. After receiving the explicit indication, the access point may transmit to the AIoT device one last radio transmission with energy_harvest=0 to indicate to the AIoT device that it has received the Tx_request and the AIoT device is expected to perform backscattering.

In an example embodiment, the implicit indication is provided such that the second AIoT device 110′ simply backscatters information directly using the radio transmissions, instead of informing the access point of becoming ready to communicate. If the access point successfully receives the implicit indication (backscattered data), the access point may cause stopping of further radio transmissions. The access point may indicate allowed slots for given AIoT devices by their IDs to use for backscattering so as to avoid collisions if there are a plurality of AIoT devices that could otherwise simultaneously transmit implicit indications.

In step 513, the access point causes termination of the energising radio transmissions on meeting a termination condition so as to avoid excessive energising radio transmissions. The termination condition may be monitored as in step 608. This step is unnecessary, if the second AIoT device 110′ has successfully backscattered information to the access point.

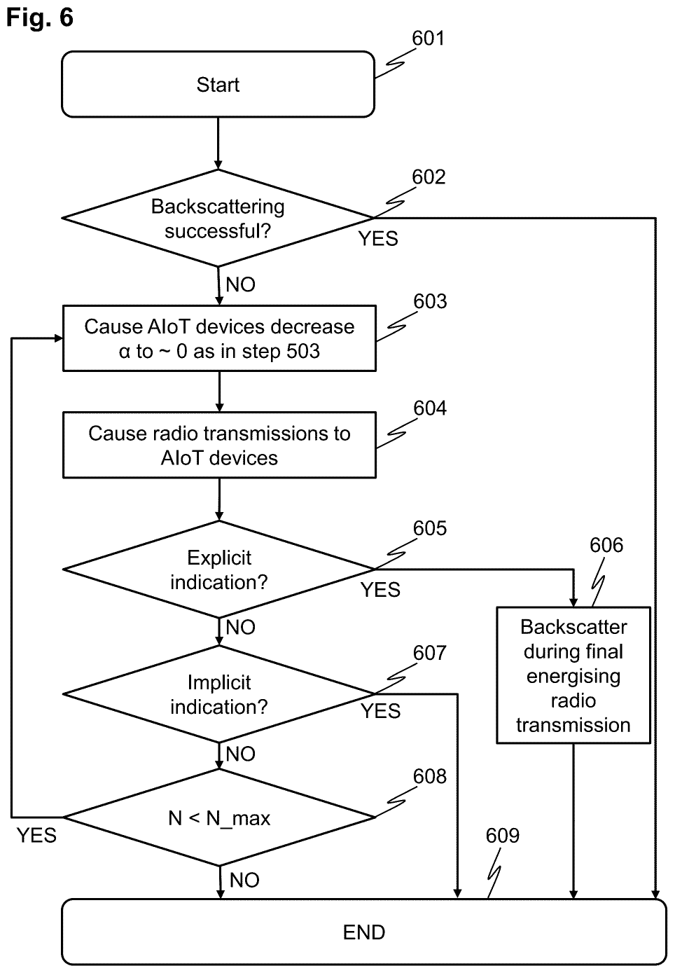

FIG. 6 shows a simplified flow chart of a method an example embodiment. The method of FIG. 6 may be used, for example, in conjunction with some example embodiments disclosed with reference to FIG. 5.

The process starts in step 601 wherein the access point attempts to communicate with the AIoT device or devices.

In 602, it is checked if backscattering of the AIoT device or devices was successfully received. If yes, the process goes to end 609, otherwise the process goes to step 603.

In step 603, the access point causes, e.g., as in step 508, the AIoT device(s) to decrease the radio reflection coefficient α to zero or close to zero to increase harvesting of energy at a higher rate.

In step 604, the access point causes transmission of energising radio transmissions to the AIoT device(s).

In step 605, the access point checks whether the AIoT device or devices has or have successfully backscattered an explicit request to stop the energising radio transmissions. If yes, the process continues to step 606, otherwise the process continues to step 607.

In step 606, the access point transmits one last radio transmission and receives information backscattered by the AIoT device as a response. The last radio transmission of the charging phase is to indicate to the AIoT device that the access point has received the explicit request and the AIoT device is expected to perform backscattering. The process then continues to step 609, which may be considered as the end of range extension procedure.

In step 607, the access point checks whether the AIoT device or devices have successfully backscattered an implicit request to end the charging phase by backscattering information as a response to receiving the radio transmission. If yes, the process continues to end 609, otherwise the process continues to step 608.

Based on the explicit indication or implicit indication, the access point becomes aware that the AIoT device has enough energy at least for some time. Thus, the access point may stop sending the radio transmissions for range extension and start to communicate with the AIoT device.

Notice: The access point may assume that the AIoT device or devices have wirelessly harvested a sufficient amount of energy in their energy storage and increased the radio reflection coefficient α at or close to 1 so as to enhance the backscattering and enable the access point or a separate reader to receive outgoing information transmitted by the AIoT devices by backscattering. However, the access point cannot know whether some particular AIoT device has increased the radio reflection of its backscattering or whether that AIoT has simply come closer to its recipient or closer to the origin of the radio transmission that is being backscattered or whether radio attenuation has decreased.

In step 608, the access point checks whether a termination condition has not yet been met. For example, the access point may use a counter configured to count the number of radio transmissions or energising radio transmissions N transmitted to the AIoT device. Alternatively, the counter may be configured to count duration of radio transmissions or energising radio transmissions transmitted to the AIoT device. For example, the access point may determine, e.g., whether a number of sent energising radio transmission N is smaller than a maximum value of N, N<N_max. Alternatively, N may be considered as a number of time periods indicating duration of an energising radio transmission. In case that the termination condition has not yet been met, the process resumes to step 603, and the counter is updated, otherwise the process continues to end 609. The maximum value of N is configured to avoid sending infinite number of energising radio transmissions in case the access points does not receive either the explicit indication or implicit indication.

In step 609, the process ends. In an example embodiment, the AIoT devices continue to operate with the increased radio reflection coefficient α at or close to 1 so that the backscattering is performed with a higher radio power.

In an example embodiment, the AIoT devices resume to their default radio reflectivity by resetting a to a default value, e.g., at 0.7 or 0.8, for balancing between backscattering range and capability to harvest energy for internal use, e.g., by the circuitry or circuitries of the AIoT devices. In an example embodiment, the AIoT devices keep using the increased a, such as ˜1, until the energy storage is depleted, and then resume to their default radio reflectivity.

In an example embodiment, the AIoT device or devices is or are energised by a series of radio transmissions. In an example embodiment, the radio transmission is a continuous radio transmission without gaps.

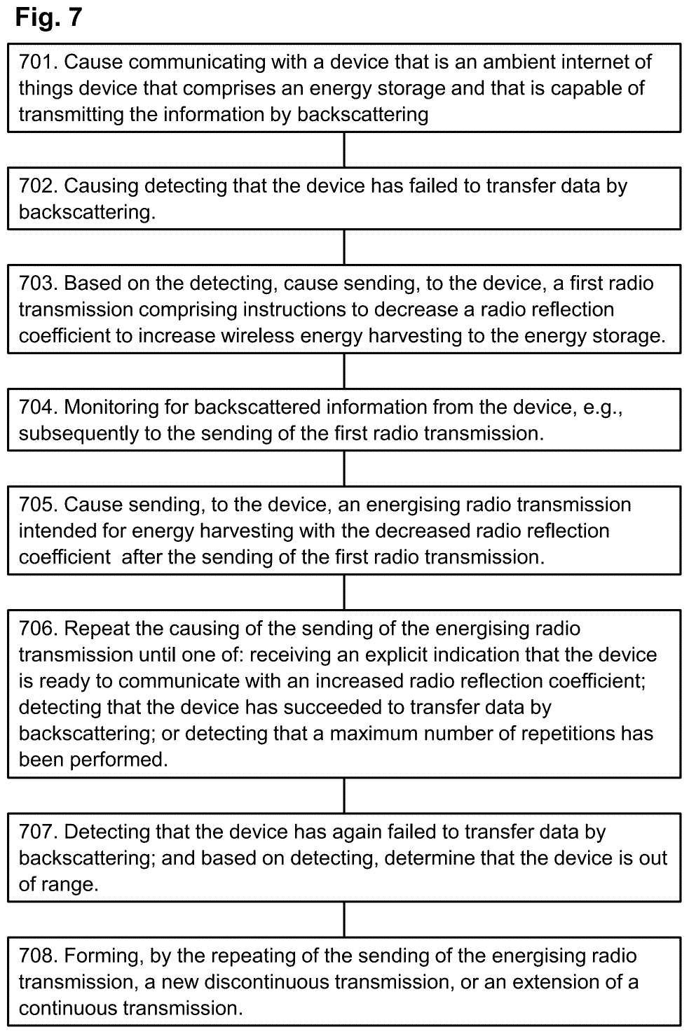

FIG. 7 shows a flow chart exemplifying a process of an example embodiment in an apparatus, such as a network apparatus or an access point, or in a controller of the apparatus, the process comprising
701. Cause communicating with a device that is an ambient internet of things device that comprises an energy storage and that is capable of transmitting the information by backscattering. In an example embodiment, the causing of the communicating with the device comprises instructing an internal access point to transmit or receive the information. In an example embodiment, the causing of the communicating with the device comprises instructing an external access point to perform transmitting or receiving of the information. In an example embodiment, receiving of the information comprises demodulating or decoding information backscattered by the ambient internet of things device.
702. Causing detecting that the device has failed to transfer data by backscattering.
703. Based on the detecting, cause sending, to the device, a first radio transmission comprising instructions to decrease a radio reflection coefficient to increase wireless energy harvesting to the energy storage. In an example embodiment, the first radio transmission is sent by an internal access point. In an example embodiment, the first radio transmission is sent by an external access point. In an example embodiment, the first radio transmission is suitable for the ambient internet of things device.
704. Monitoring for backscattered information from the device, e.g., subsequently to the sending of the first radio transmission.
705. Cause sending, to the device, an energising radio transmission for energy harvesting with the decreased radio reflection coefficient after the sending of the first radio transmission.
706. Repeat the causing of the sending of the energising radio transmission until one of:
   receiving an explicit indication that the device is ready to communicate with an increased radio reflection coefficient;
   detecting that the device has succeeded to transfer data by backscattering; or
   detecting that a maximum number of repetitions has been performed.
707. Detecting that the device has again failed to transfer data by backscattering; and based on detecting, determine that the device is out of range.
708. Forming, by the repeating of the sending of the energising radio transmission, a new discontinuous transmission, or an extension of a continuous transmission.

Detecting that the device has failed to transfer data by backscattering is to be understood so that the device might have transmitted the data, but the reader device has not succeeded to receive the data, e.g., due to inefficient backscattering. Thus, the data is not actually transferred from the device to the reader.

The process may be performed or caused by a controller of the apparatus. In an example embodiment, the controller comprises at least one processor. In an example embodiment, the controller comprises at least one memory. In an example embodiment, the apparatus is a 5G node B, gNB. In an example embodiment, the apparatus comprises a network interface configured to communicate with a cellular network and to receive a device communication request from the cellular network. In an example embodiment, the controller is further configured to detect the device communication request, and to responsively cause the first attempt of communicating with the device by the proximity communication circuitry. In an example embodiment, the apparatus is a UE.

In an example embodiment, the process further comprises specifically directing one or more communications to the device using at least an identifier of the device. In an example embodiment, the energy harvesting is increased from a zero level. That is, in some cases, e.g., because of hardware or positioning of the AIoT device, or both, there may be no energy harvesting present before increasing the energy harvesting with the increase of the radio reflection coefficient. In an example embodiment, the energy harvesting is increased from a level greater than zero.

In an example embodiment, the process further comprises receiving a device communication request from a cellular network. In an example embodiment, the process further comprises detecting the device communication request, and responsively causing the first attempt of communicating with the ambient internet of things device.

In an example embodiment, the reduced radio reflection coefficient is as small as possible, e.g., at most 0.5%, 1% or 5%.

In an example embodiment, the increased radio reflection coefficient is as great as possible, e.g., at least 95%, 99%, or 99.5%.

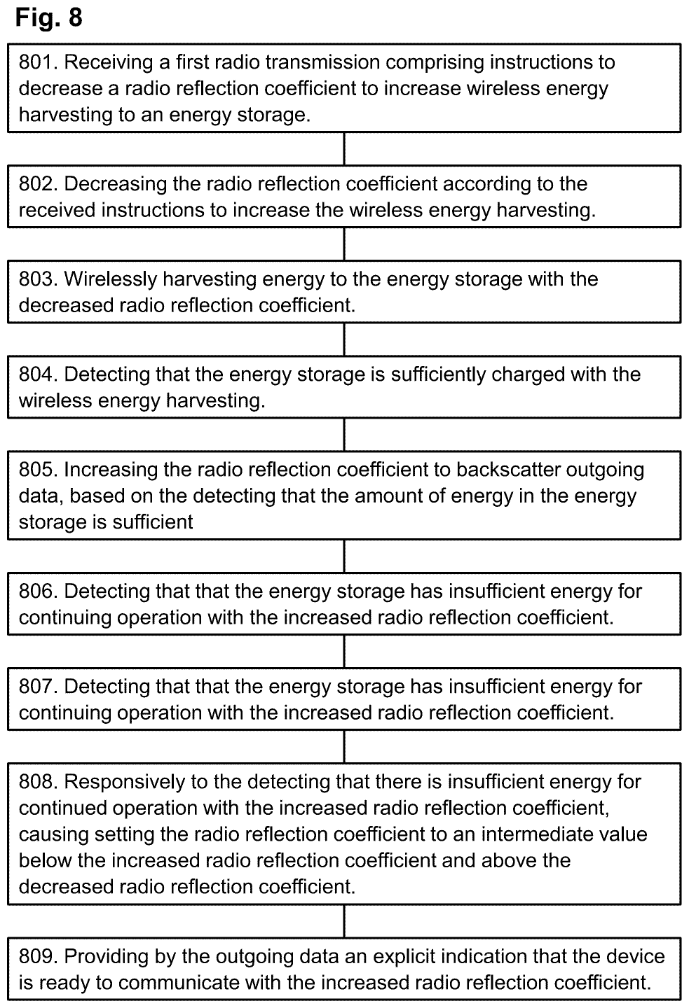

FIG. 8 shows a flow chart exemplifying a process of an example embodiment in a device, such as an ambient internet of things device, such as the device 400 of FIG. 4, the process comprising
801. Receiving a first radio transmission comprising instructions to decrease a radio reflection coefficient to increase wireless energy harvesting to an energy storage.
802. Decreasing the radio reflection coefficient according to the received instructions to increase the wireless energy harvesting.
803. Wirelessly harvesting energy to the energy storage with the decreased radio reflection coefficient. In an example embodiment, wireless harvesting of energy to the energy storage may be performed also before decreasing the radio reflection coefficient and the decreasing the radio reflection coefficient increases a rate with which the energy storage is charged.
804. Detecting that the energy storage is sufficiently charged with the wireless energy harvesting.
805. Increasing the radio reflection coefficient to backscatter outgoing data, based on the detecting that the amount of energy in the energy storage is sufficient. On increasing of the radio reflection coefficient of the radio circuitry, operating power may be supplied to the one or more circuitries with operating power from the energy storage. In an example embodiment, the supplying of the operating power provides all the operating power of the supplied circuitry or circuitries. In an example embodiment, the supplying of the operating power provides a portion of the operating power required by the circuitry or circuitries, while another portion of the operating power is obtained by wireless harvesting. That is, the energy storage may remove a need or at least reduce the need of wireless harvesting of energy.

The process may further comprise any one or more of the following:
806. Detecting that that the energy storage has insufficient energy for continuing operation with the increased radio reflection coefficient.
807. Responsively to the detecting that there is insufficient energy for continued operation with the increased radio reflection coefficient, causing setting the radio reflection coefficient to an intermediate value below the increased radio reflection coefficient and above the decreased radio reflection coefficient.
808. Causing an attempt to transfer data to the apparatus by backscattering, before receiving the first radio transmission comprising instructions to decrease the radio reflection coefficient to increase wireless energy harvesting.
809. Providing by the outgoing data an explicit indication that the device is ready to communicate with the increased radio reflection coefficient.

As used in this application, the term “circuitry” may refer to one or more or all of the following:
(a) hardware-only circuit implementations (such as implementations in only analogue and/or digital circuitry) and;
(b) combinations of hardware circuits and software, such as (as applicable):
   (i) a combination of analogue and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Without in any way limiting the scope, interpretation, or application of the claims appearing below, a technical effect of one or more of the example embodiments disclosed herein is that range of ambient internet of things devices may be increased. Another technical effect of one or more of the example embodiments disclosed herein is that the range of the ambient internet of things devices may be increased using local energy storage only where necessary so avoiding unnecessary delays when the ambient internet of things devices are readily capable of communicating by backscattering an energising radio transmission. Yet another technical effect of one or more of the example embodiments disclosed herein is that increasing the range of the ambient internet of things devices through increased radio reflection coefficient avoids a need to increase radio power of the energising radio transmission, so avoiding increase of radio interference and energy consumption. Still further technical effect of one or more of the example embodiments disclosed herein is that very little resources are needed to for the increase of the range, and overall energy efficiency may be enhanced.

Embodiments may be implemented in software, hardware, application logic or a combination of software, hardware, and application logic. The software, application logic and/or hardware may reside on the network apparatus, on a controller of the network apparatus, on the AIoT device, or on the control circuitry of the AIoT device. If desired, part of the software, application logic and/or hardware may reside on the network apparatus, part of the software, application logic and/or hardware may reside on the AIoT device, and part of the software, application logic and/or hardware may reside on an external access point or illuminator. In an example embodiment, the application logic, software, or an instruction set is maintained on any one of various conventional computer-readable media. In the context of this document, a “computer-readable medium” may be any non-transitory media or means that can contain, store, communicate, propagate, or transport the instructions for use by or in connection with an instruction execution system, apparatus, or device, such as a computer, with one example of a computer described and depicted in FIG. 3 or 4. A computer-readable medium may comprise a computer-readable storage medium that may be any media or means that can contain or store the instructions for use by or in connection with an instruction execution system, apparatus, or device, such as a computer. The term non-transitory as used herein is a limitation of the medium itself (i.e., tangible, not a signal) as opposed to a limitation on data storage persistency (e.g., random access memory vs. read only memory).

If desired, the different functions discussed herein may be performed in a different order and/or concurrently with each other. Furthermore, if desired, one or more of the before-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications which may be made without departing from the scope as defined in the appended claims.

1. A device, wherein the device is an ambient internet of things device configured to wirelessly harvest energy from a radio transmission and communicate with an apparatus by backscattering the radio transmission, the device, comprising at least:
an energy storage;
at least one processor; and
at least one memory storing instructions that, when executed by the at least one processor, cause the device at least to:
receive a first radio transmission comprising instructions to decrease a radio reflection coefficient to increase wireless energy harvesting to the energy storage;
decrease the radio reflection coefficient according to the received instructions to increase the wireless energy harvesting;
detect that the energy storage is sufficiently charged with the wireless energy harvesting; and
based on the detecting that the amount of energy in the energy storage is sufficient, increase the radio reflection coefficient to backscatter outgoing data.

2. The device of claim 1, wherein the instructions, when executed by the at least one processor, further cause the device at least to:
detect that the energy storage has insufficient energy for continuing operation with the increased radio reflection coefficient, and responsively
cause setting of the radio reflection coefficient to an intermediate value below the increased radio reflection coefficient and above the decreased radio reflection coefficient.

3. The device of claim 1, the outgoing data comprising an explicit indication that the device is ready to communicate with the increased radio reflection coefficient.

4. An apparatus comprising at least one processor; and at least one memory storing instructions that, when executed by the at least one processor, cause the apparatus at least to:
cause communicating with a device, wherein the device is an ambient internet of things device with an energy storage and wherein the device is capable of transmitting data by backscattering a radio transmission;
cause detecting that the device has failed to transfer data by backscattering; and
based on the detecting, cause sending, to the device, a first radio transmission comprising instructions to decrease a radio reflection coefficient to increase wireless energy harvesting to the energy storage; and
monitoring for backscattered information from the device.

5. The apparatus of claim 4, wherein the instructions, when executed by the at least one processor, further cause the apparatus at least to:
cause sending, to the device, an energising radio transmission for energy harvesting with the decreased radio reflection coefficient after the sending of the first radio transmission.

6. The apparatus of claim 5, wherein the instructions, when executed by the at least one processor, further cause the apparatus at least to:
repeat the causing of the sending of the energising radio transmission until one of:
receiving an explicit indication that the device is ready to communicate with an increased radio reflection coefficient;
detecting that the device has succeeded to transfer data by backscattering; or
detecting that a maximum number of repetitions has been performed.

7. The apparatus of claim 6, wherein the instructions, when executed by the at least one processor, further cause the apparatus at least to:
receive the explicit indication that the device is ready to communicate with the increased radio reflection coefficient; and
based on the explicit indication, transmit an additional radio transmission comprising instructions to increase the radio reflection coefficient to decrease wireless energy harvesting.

8. The apparatus of claim 6, wherein the instructions, when executed by the at least one processor, further cause the apparatus at least to:
detecting that the device has again failed to transfer data by backscattering; and
based on detecting, determining that the device is out of range.

9. The apparatus of claim 6, wherein the repeating of the sending of the energising radio transmission is configured to form a series of finite number of transmissions of a fixed duration.

10. A method comprising:
receiving, by a device, a first radio transmission comprising instructions to decrease a radio reflection coefficient to increase wireless energy harvesting to an energy storage; wherein the device is an ambient internet of things device comprising the energy storage;
decreasing, by the device, the radio reflection coefficient according to received instructions to increase wireless energy harvesting;
detecting, by the device, that the energy storage is sufficiently charged with the wireless energy harvesting; and
based on the detecting that the energy storage is sufficient charged with the wireless energy harvesting, increasing, by the device, the radio reflection coefficient to backscatter outgoing data.

11. The method of claim 10, further comprising
detecting, by the device, that the energy storage has insufficient energy for continuing operation with the increased radio reflection coefficient, and responsively
causing, by the device, setting the radio reflection coefficient to an intermediate value below the increased radio reflection coefficient and above that for the decreasing of the radio reflection coefficient.

12-14. (canceled)

15. A computer program stored on a non-transitory memory medium, comprising computer executable program instructions configured to: cause a device to perform the method of claim 10.
